(19) United States
(12) Patent Application Publication
(10) Pub. No.: US 2024/0185185 A1
(43) Pub. Date: Jun. 6, 2024

(54) SCHEDULE SETTING SYSTEM, SCHEDULE SETTING SERVER, AND PROGRAM

(71) Applicant: DENTSU INC., Tokyo (JP)

(72) Inventors: Dai ARAKAWA, Tokyo (JP); Rina AKINO, Tokyo (JP); Wataru KISHIMOTO, Tokyo (JP)

(73) Assignee: DENTSU INC., Tokyo (JP)

(21) Appl. No.: 18/285,681

(22) PCT Filed: Mar. 14, 2022
(86) PCT No.: PCT/JP2022/011344

§ 371 Date: Oct. 5, 2023

(30) Foreign Application Priority Data
Apr. 8, 2021 (JP) 2021-065861

(51) Int. Cl. G06Q 10/1093

(52) U.S. Cl. CPC G06Q 10/1093

(57) ABSTRACT

A schedule setting system slides desired date and time of an event included in acquired schedule information or desired date and time of a changeable schedule within a buffer time set in advance by a unit time when a type of the event is semi-fixed, and the desired date and time of the event included in the schedule information overlaps with desired date and time of a confirmed schedule or a changeable schedule of a member participating in the event. When an overlap between the desired date and time of the event included in the schedule information and the desired date and time of the confirmed schedule or the changeable schedule of the member participating in the event is eliminated, a changeable schedule is set to the slid desired date and time, and the changeable schedule is set to a confirmed schedule of desired date and time at a predetermined timing.

### TECHNICAL FIELD

The present disclosure relates to a schedule setting system, a schedule setting server, and a program.

### BACKGROUND ART

Conventionally, a technique for adjusting schedules of members participating in an event such as a meeting, a regular meeting, or work has been provided. In such a technique, a system that supports schedule management work of each member is known (see Patent Document 1, for example).

### PRIOR ART DOCUMENT

### Patent Document

Patent Document 1: Japanese Laid-open Patent Publication No. 2005-004307

### SUMMARY OF INVENTION

### Technical Problem

However, when the schedule of the member is confirmed, and then a new event is received, the desired date and time of the event and the desired date and time of the confirmed schedule may overlap with each other. In such a case, it is necessary to re-schedule the schedules of the members participating in the event including the confirmed schedule, and it takes time to set the schedules.

Therefore, one object of the present disclosure is to provide a schedule setting system, a schedule setting server, a schedule setting method, and a program capable of quickly setting a schedule of a member participating in an event.

### Solution to Problem

A schedule setting system according to an aspect of the present disclosure includes an acquisition unit that acquires schedule information including information on a member participating in an event, information on desired date and time of the event, and information on a type of the event, and a control unit that sets a schedule including a confirmed schedule or a changeable schedule based on the schedule information. The control unit sets a confirmed schedule to the desired date and time included in the schedule information when the type of the event is a first type, and the desired date and time of the event included in the schedule information does not overlap with desired date and time of a confirmed schedule of the member participating in the event, sets a changeable schedule to the desired date and time when the type of the event is a second type, and the desired date and time of the event included in the schedule information does not overlap with desired date and time of a confirmed schedule or a changeable schedule of the member participating in the event, slides the desired date and time of the event or the desired date and time of the changeable schedule of the member participating in the event, within a buffer time set in advance by a unit time when the desired date and time of the event included in the schedule information overlaps with the desired date and time of the confirmed schedule or the changeable schedule of the member participating in the event, and sets a changeable schedule to the slid desired date and time when an overlap between the desired date and time of the event included in the schedule information and the desired date and time of the confirmed schedule or the changeable schedule of the member participating in the event is eliminated as a result obtained by sliding the desired date and time of the event or the desired date and time of the changeable schedule, and sets the changeable schedule as a confirmed schedule of the desired date and time at a predetermined timing.

### Advantageous Effects of Invention

According to an aspect of the present disclosure, it is possible to quickly set a schedule of a member participating in an event.

### BRIEF DESCRIPTION OF DRAWINGS

FIG. 1 is a diagram illustrating an example of a schematic configuration of a schedule setting system according to an embodiment.

FIG. 2 is a diagram illustrating an example of a flowchart of schedule setting processing by a schedule setting method according to the embodiment.

FIG. 3 is a diagram illustrating an example of a flowchart of a first adjustment process executed in FIG. 2.

FIG. 4 is a diagram illustrating an example of setting a changeable schedule of an event to desired date and time at which a continuous vacant time of each member becomes maximum.

FIG. 5 is a diagram illustrating an example of a flowchart of a second adjustment process executed in FIG. 2.

FIG. 6 is a diagram illustrating an example of a flowchart of a confirmed-schedule setting process by a schedule setting method according to the embodiment.

FIG. 7 is a diagram illustrating an example of a schedule of a member participating in an event.

FIG. 8 is a diagram illustrating an example in which desired date and time of a set changeable schedule are set again by being slid.

FIG. 9 is a diagram illustrating an example in which desired date and time of a changeable schedule is set by sliding desired date and time of an event.

FIG. 10 is a diagram illustrating an example of list information input in a ToDo format.

FIG. 11 is a diagram illustrating an example of a functional configuration of a schedule setting server according to an embodiment.

FIG. 12 is a diagram illustrating an example of a hardware configuration of a schedule setting server and the like according to an embodiment.

### DESCRIPTION OF EMBODIMENTS

Hereinafter, embodiments of the present disclosure will be described in detail with reference to the accompanying drawings. In the following description, the same parts are denoted by the same reference signs. Since the same parts have the same names, functions, and the like, detailed descriptions thereof will not be repeated.

### (Schedule Setting System)

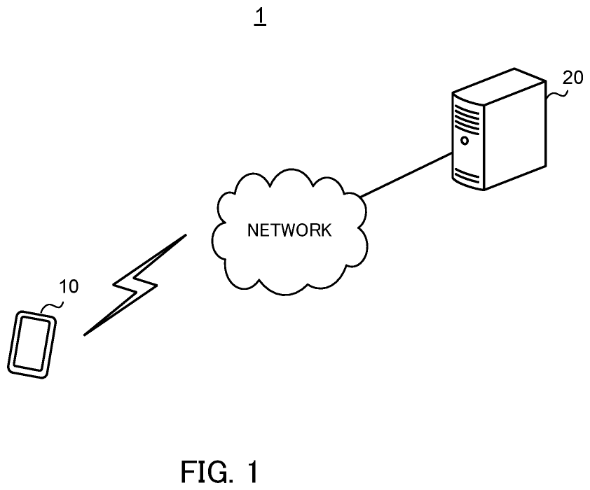

FIG. 1 is a diagram illustrating an example of a schematic configuration of a schedule setting system according to an embodiment. A schedule setting system 1 illustrated in FIG. 1 includes a device 10 and a schedule setting server 20.

The device 10 may be a portable terminal (mobile communication terminal) such as a portable phone, a smartphone, or a tablet terminal, or may be a fixed communication terminal such as a personal computer (PC) or a server. That is, the device 10 in the present disclosure can be read as a communication device.

The device 10 may communicate with a network (such as the Internet) by a wire and/or wireless (for example, Long Term Evolution (LTE), 5th Generation New Radio (5G NR), Wi-Fi (registered trademark), and the like).

The schedule setting server 20 may be a fixed communication terminal such as a personal computer (PC) or a server. The schedule setting server 20 may be a server that acquires schedule information of a user, which is input to the device 10. Furthermore, the schedule setting server 20 may directly acquire the input schedule information in response to the operation of the user without using the device 10. The server in the present disclosure may be read as an apparatus, a device, a circuit, or the like.

An example of a functional configuration and a hardware configuration of each device such as the device 10 will be described later.

The system configuration is an example, and the present disclosure is not limited thereto. For example, each device is configured to be included one by one in FIG. 1, but the number of devices is not limited thereto, and a plurality of devices may be provided. The schedule setting system 1 may be configured not to include some devices, or may be configured such that the function of one device is realized by a plurality of devices.

A configuration in which the functions of a plurality of devices are realized by one device may be made. For example, the device 10 and the schedule setting server 20 may be implemented on one server.

### (Schedule Setting Method)

A schedule setting method according to the embodiment of the present disclosure will be described below. Each schedule setting method may be applied to the schedule setting system 1 described above.

### <Schedule Setting>

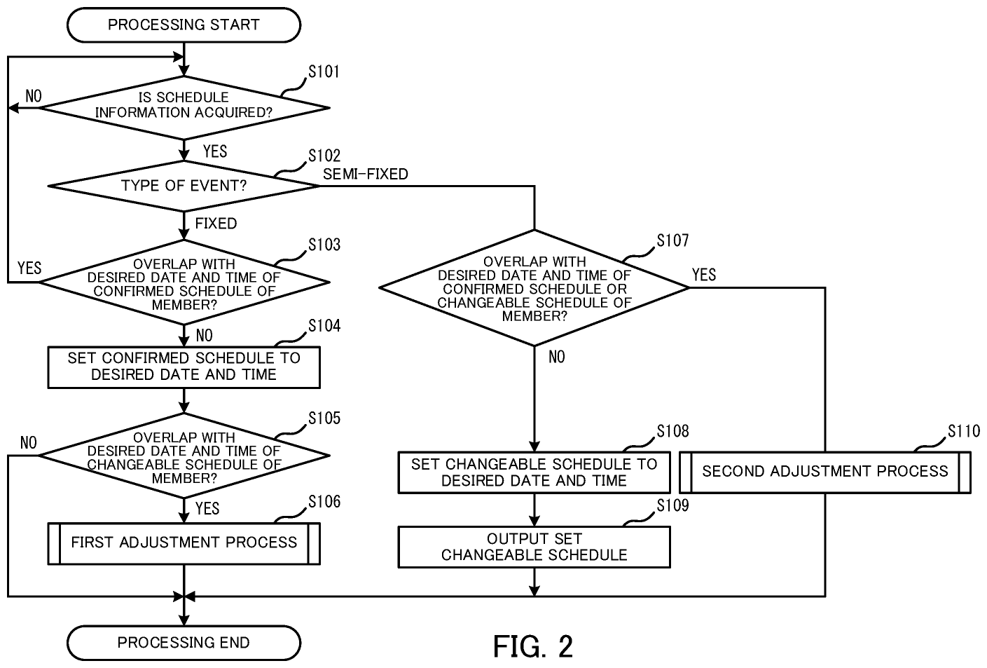

FIG. 2 is a diagram illustrating an example of a flowchart of schedule setting processing by a schedule setting method according to an embodiment.

First, the schedule setting server 20 acquires schedule information. The schedule information is information on an event input to the device 10 based on the operation of the user. The schedule information includes information on members participating in the event, information on desired date and time of the event, and information on the type of the event. The schedule information may include information other than the information on the member participating in the event, the information on the desired date and time of the event, and the information on the type of the event.

The user can be read as a member participating in the event. A member participating in the event may be a person other than the user who inputs the schedule information to the device 10. The event is a schedule of a consultation, a regular meeting, a meeting, or the like. The event may be a schedule of work of the user, a convention, a conference, a council, or the like.

The information on the members is information capable of uniquely identifying a plurality of members. The information on the members may be, for example, a family name, a name, a nickname, alphanumeric characters, or an identification symbol of a member.

The information on the desired date and time is date and time at which the event is desired to be held. The information on the desired date and time may be information on a date of holding the event, a start time, a holding time slot, a time from the start to the end of the event, or a day of the week.

The information on the desired date and time includes the working time of the event. The working time refers to a time estimated to be necessary for performing an event. The working time may be set in units of year, month, day, hour, minute, and second, for example. The information on the desired date and time may include information on a work deadline. The work deadline refers to the last date and time at which an event is performed.

As the information on the type of event, at least two types of events can be freely set. The type of event may include a first type and a second type. The type of event may include three or more types. In the present disclosure, the first type of event is also referred to as “fixed (confirmed event)”, and the second type of event is also referred to as “semi-fixed (changeable event)”.

The schedule setting server 20 sets a schedule including a confirmed schedule or a changeable schedule based on the acquired schedule information. The schedule setting server 20 may set a confirmed schedule to the desired date and time when the type of the event is fixed, and may set a changeable schedule to the desired date and time when the type of the event is semi-fixed. The information on the desired date and time of the confirmed schedule and the desired date and time of the changeable schedule may be stored in the schedule setting server 20 for each member. The information on the desired date and time of the confirmed schedule and the desired date and time of the changeable schedule may be stored in the device 10 for each member. The information on the desired date and time of the confirmed schedule and the desired date and time of the changeable schedule may be stored in another device not illustrated in FIG. 1.

The confirmed schedule is a schedule in which the date and time for holding an event is fixed based on the desired date and time. The desired date and time of the confirmed schedule is not slid based on the influence of a confirmed schedule or another changeable schedule. That is, if the desired date and time of the confirmed schedule is set once, the desired date and time of the confirmed schedule is not changed. When the confirmed schedule is set, the date and time at which the event is held may be fixed. The changeable schedule is a schedule in which the date and time for holding an event is temporarily fixed based on the desired date and time. The desired date and time of the changeable schedule is slid based on the influence of a confirmed schedule or another changeable schedule. That is, even when the desired date and time of the changeable schedule is set once, the desired date and time of the changeable schedule may be changed in a case where reservation information of a new event is acquired.

The schedule information may further include information on a buffer time of the event. The buffer time refers to a margin or spare time for the desired date and time of the event. Within the buffer time, the desired date and time of the event or the desired date and time of the changeable schedule may be slid for each unit time. The sliding may be before, after, or before or after the desired date and time. As the unit time, the hour, the minute, and the second may be set. When the changeable schedule is set, only a time frame corresponding to the buffer time of the event may be fixed, and the date and time for holding the event may be slid. The buffer time may be set based on a calendar such as the year, the month, the week, or the day, or a time slot such as the morning, the afternoon, or the lunch break.

The information on the buffer time of the event may be set in advance separately from the schedule information. The information on the changeable schedule may include information on the buffer time in addition to the information on the desired date and time of the event. When the changeable schedule is set, only a time frame of the event may be fixed within the buffer time, and the date and time for holding the event may change.

The information on the confirmed schedule may include the information on the desired date and time of the event. The information on the changeable schedule may include information on the desired date and time of the event and the information on the buffer time of the event.

Therefore, for an event for which it is not desired to change the date and time, that is, for which the change of the date and time is not allowed, the user may set “fixed” as the type of event. In addition, for an event for which the date and time may be changed, that is, for which the change of the date and time is allowed, the user may set “semi-fixed” as the type of event.

The schedule setting server 20 determines whether or not the schedule information transmitted from the device 10 has been acquired (Step S101). When the schedule information has not been acquired (Step S101: NO), the process stands by until the schedule information is acquired.

When the schedule information has been acquired (Step S101: YES), the schedule setting server 20 determines the type of the event included in the schedule information (Step S102). When the type of the event included in the schedule information is fixed (Step S102: fixed), the schedule setting server 20 causes the process to proceed to Step S103.

In Step S103, the schedule setting server 20 determines whether or not the desired date and time of the event included in the acquired schedule information overlaps with desired date and time of a confirmed schedule of a member participating in the event (Step S103). The determination as to whether or not there is the overlap with desired date and time may be performed based on whether or not the entirety or a part of a time between the start time and the end time of the event overlaps with the desired date and time of the confirmed schedule. When the desired date and time of the event included in the acquired schedule information overlaps with desired date and time of a confirmed schedule of a member participating in the event (Step S103: YES), the schedule setting server 20 cancels the acquired schedule information and causes the process to return to Step S101. In this case, the schedule setting server 20 may notify the device 10 of information indicating that the desired date and time overlaps with the confirmed schedule of the member participating in the event. The device 10 that has received the notification may notify the user of the device 10 of a message indicating that the desired date and time overlaps with the confirmed schedule of the member participating in the event.

When the desired date and time of the event included in the acquired schedule information does not overlap with desired date and time of a confirmed schedule of a member participating in the event (Step S103: NO), the schedule setting server 20 sets a confirmed schedule to the desired date and time included in the acquired schedule information (Step S104).

The schedule setting server 20 determines whether or not the desired date and time of the event included in the acquired schedule information overlaps with desired date and time of a changeable schedule of a member participating in the event (Step S105). The determination as to whether or not there is the overlap with desired date and time may be performed based on whether or not the entirety or a part of a time between the start time and the end time of the event overlaps with the desired date and time of the changeable schedule. When the desired date and time of the event included in the acquired schedule information does not overlap with desired date and time of a changeable schedule of a member participating in the event (Step S105: NO), the schedule setting processing is ended. That is, in this case, the confirmed schedule is set to the desired date and time included in the schedule information without the need to slide desired date and time, and the process is ended.

When the desired date and time of the event included in the acquired schedule information overlaps with desired date and time of a changeable schedule of a member participating in the event (Step S105: YES), the schedule setting server 20 executes a first adjustment process (Step S106).

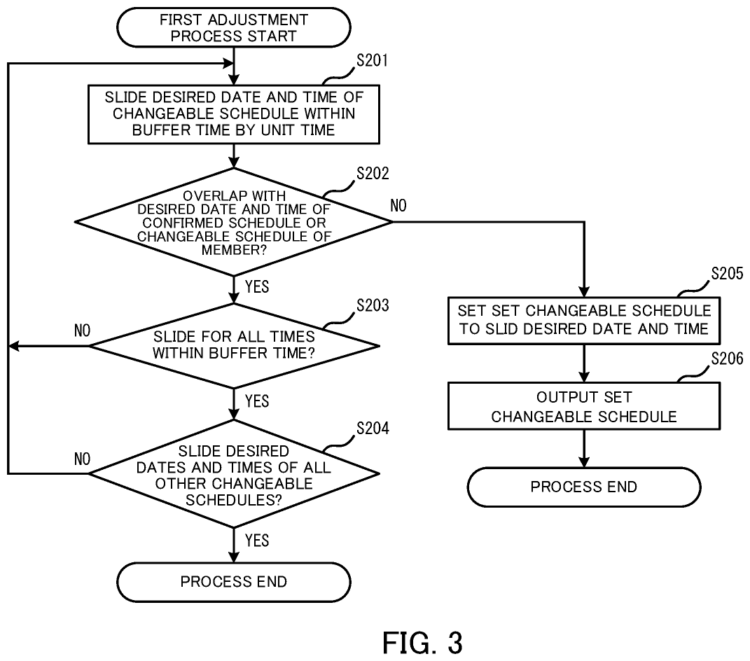

FIG. 3 is a diagram illustrating an example of a flowchart of the first adjustment process executed in Step S106 of FIG. 2.

When the desired date and time of the event included in the acquired schedule information overlaps with desired date and time of a changeable schedule of a member participating in the event, the schedule setting server 20 slides the desired date and time of the changeable schedule within a buffer time by a unit time (Step S201). For example, when the unit time is 30 minutes in the changeable schedule in which 10:00 is set as the desired date and time, the schedule setting server 20 slides the desired date and time of the changeable schedule from 10:00 to 10:30.

The schedule setting server 20 determines whether or not the desired date and time of the event included in the acquired schedule information overlaps with desired date and time of a confirmed schedule or a changeable schedule of a member participating in the event (Step S202).

When the desired date and time of the event included in the acquired schedule information overlaps with desired date and time of a confirmed schedule or a changeable schedule of a member participating in the event (Step S202: YES), the process proceeds to Step S203. That is, when the overlap between the desired date and time of the event and the desired date and time of the confirmed schedule or the changeable schedule of the member participating in the event is not eliminated even though the desired date and time of the changeable schedule is slid within the buffer time by the unit time, the process proceeds to Step S203.

In Step S203, the schedule setting server 20 determines whether or not the desired date and time of the changeable schedule has been slid for all the times within the buffer time. For example, when the buffer time is set to two hours for the changeable schedule in which 10:00 is set as the desired date and time, it is determined whether or not the desired date and time of the changeable schedule has been slid for all the times within the buffer time from 8:00 to 12:00 for each unit time. When the unit time is 30 minutes, the schedule setting server 20 can slide the desired date and time in order of 10:00, 10:30, 11:00, 11:30, and 12:00. Furthermore, the schedule setting server 20 can slide the desired date and time in order of 10:00, 9:30, 9:00, 8:30, and 8:00. When the desired date and time of the changeable schedule has not been slid for all the times within the buffer time (Step S203: NO), the process returns to Step S201. That is, the processes of Steps S201 to S203 are repeatedly executed until the desired date and time of the changeable schedule is slid for all the times within the buffer time or the overlap between the desired date and time of the event included in the acquired schedule information and the desired date and time of the confirmed schedule or the changeable schedule of the member participating in the event is eliminated.

When the desired date and time of the changeable schedule has been slid for all the times within the buffer time (Step S203: YES), the schedule setting server 20 determines whether or not desired dates and times of all the other changeable schedules have been slid (Step S204). When the desired dates and times of all the other changeable schedules have not been slid (Step S204: NO), the process returns to Step S201.

That is, the processes of Steps S201 to S204 are repeatedly executed until the desired dates and times of all the other changeable schedules are slid or the overlap between the desired date and time of the event included in the acquired schedule information and the desired date and time of the confirmed schedule or the changeable schedule of the member participating in the event is eliminated. When the desired dates and times of all the other changeable schedules have been slid (Step S204: YES), the first adjustment process illustrated in FIG. 3 is ended. When the first adjustment process is ended, the schedule setting processing illustrated in FIG. 2 is also ended.

When the desired date and time of the event included in the acquired schedule information does not overlap with desired date and time of a confirmed schedule or a changeable schedule of a member participating in the event (Step S202: NO), the process proceeds to Step S205.

The schedule setting server 20 sets the set changeable schedule to the slid desired date and time (Step S205). That is, when the overlap between the desired date and time of the event and the desired date and time of the confirmed schedule or the changeable schedule of the member participating in the event is eliminated as a result obtained by sliding the desired date and time of the changeable schedule within the buffer time by the unit time, the schedule setting server 20 sets the set changeable schedule to the slid desired date and time.

When a plurality of combinations of the desired date and time of the event included in the acquired schedule information and desired date and time of a confirmed schedule or a changeable schedule of each member participating in the event are provided as a result obtained by sliding the desired date and time of the changeable schedule, the schedule setting server 20 may set the set changeable schedule to the desired date and time corresponding to the pattern of the optimum condition.

As the pattern of the optimum condition, for example, the set changeable schedule may be set to the desired date and time having the smallest overlap among combinations of the desired date and time of the event included in the acquired schedule information and desired date and time of a confirmed schedule or a changeable schedule of each member participating in the event. As a result, it is possible to maximize the number of members participating in the event.

In addition, as the pattern of the optimum condition, for example, the changeable schedule of the event may be set to the desired date and time at which a continuous vacant time of each member becomes maximum among combinations of the desired date and time of the event included in the acquired schedule information and desired date and time of a confirmed schedule or a changeable schedule of each member participating in the event. As a result, it is possible for each member to take a continuous vacant time, and to efficiently use the time.

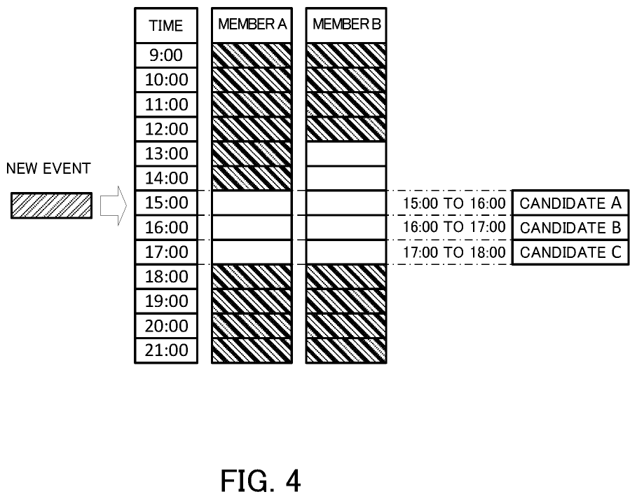

FIG. 4 is a diagram illustrating an example of setting a changeable schedule of an event to desired date and time at which a continuous vacant time of each member becomes maximum. In FIG. 4, an example of setting a changeable schedule of a new event of one hour will be described. In FIG. 4, the vacant time of the member A is 15:00 to 18:00, and the vacant time of the member B is 13:00 to 18:00. In the example of FIG. 4, for simple description, it is assumed that a schedule can be set every hour. However, the schedule setting is not limited to every hour, and the schedule can be set every predetermined unit time.

When a changeable schedule of a new event of 1 hour is set in the vacant time of each of the members A and B, the changeable schedule can be set to three candidates of a candidate A of 15:00 to 16:00, a candidate B of 16:00 to 17:00, and a candidate C of 17:00 to 18:00.

Here, if a schedule of a new event is set to the candidate A, the vacant time of the member A is not divided, but the vacant time of the member B is divided into 13:00 to 15:00 and 16:00 to 18:00. Similarly, when the schedule of the new event is set to the candidate B, the vacant time of the member A is divided into 15:00 to 16:00 and 17:00 to 18:00, and the vacant time of the member B is divided into 13:00 to 16:00 and 17:00 to 18:00. On the other hand, when the schedule of the new event is set to the candidate C, the vacant time of the member A and the vacant time of the member B are not divided, and the continuous vacant time of each member becomes maximum.

Therefore, by setting the schedule of the new event to the candidate C as the pattern of the optimum condition, it is possible to set a changeable schedule of the event to the desired date and time at which the continuous vacant time of each member becomes maximum, and it is possible to efficiently use the vacant time of each member.

Furthermore, as the pattern of the optimum condition, for example, the set changeable schedule may be set to the earliest desired date and time among combinations of the desired date and time of the event included in the acquired schedule information and desired date and time of a confirmed schedule or a changeable schedule of each member participating in the event. This makes it possible to hold the event as soon as possible.

The schedule setting server 20 outputs information on the set changeable schedule to the device 10 (Step S206). The schedule setting server 20 may output the information on the set changeable schedule to the device 10 owned by the member participating in the event. The device 10 acquires the information on the changeable schedule, which has been output from the schedule setting server 20. The device 10 displays the acquired information on the changeable schedule. The device 10 may display the acquired information on the changeable schedule only when logging in to device 10 with the account of the member participating in the event. The schedule setting server 20 may output the information on the set changeable schedule to the schedule setting server 20 itself or a device not illustrated in FIG. 1.

When the overlap between the desired date and time of the event included in the schedule information and the desired date and time of the confirmed schedule or the changeable schedule of the member participating in the event is eliminated as a result obtained by sliding the desired date and time of the changeable schedule, the schedule setting server 20 may output the information on the slid desired date and time of the changeable schedule to the device 10. The schedule setting server 20 may output candidates for the desired date and time of the changeable schedule obtaining by sliding to the device 10 as schedule candidates.

When the process of Step S205 is ended, the first adjustment process illustrated in FIG. 3 is ended. When the first adjustment process is ended, the schedule setting processing illustrated in FIG. 2 is also ended.

The description returns to the process of Step S102 in FIG. 2. When the type of the event included in the schedule information is semi-fixed (Step S102: semi-fixed), the process proceeds to Step S107. In Step S107, the schedule setting server 20 determines whether or not the desired date and time of the event included in the acquired schedule information overlaps with desired date and time of a confirmed schedule or a changeable schedule of a member participating in the event. The determination as to whether or not there is the overlap with desired date and time may be performed based on whether or not the entirety or a part of a time between the start time and the end time of the event overlaps with the desired date and time of the confirmed schedule or the changeable schedule.

When the desired date and time of the event included in the acquired schedule information does not overlap with desired date and time of a confirmed schedule or a changeable schedule of a member participating in the event (Step S107: NO), the schedule setting server 20 sets a changeable schedule to the desired date and time of the event (Step S108). That is, when the desired date and time of the event included in the acquired schedule information does not overlap with any of desired dates and times of confirmed schedules and desired dates and times of changeable schedules that have already been set, the schedule setting server 20 temporarily sets the event as a changeable schedule.

The schedule setting server 20 temporarily sets a changeable schedule to the desired date and time in the schedule information (Step S108). The schedule setting server 20 outputs information on the set changeable schedule to the device 10 (Step S109). The schedule setting server 20 may output the information on the set changeable schedule to the device 10 owned by the member participating in the event. The device 10 acquires the information on the changeable schedule, which has been output from the schedule setting server 20. The device 10 displays the acquired information on the changeable schedule. The device 10 may display the acquired information on the changeable schedule only when logging in to device 10 with the account of the member participating in the event. The schedule setting server 20 may output the information on the set changeable schedule to the schedule setting server 20 itself or a device not illustrated in FIG. 1.

When the process of Step S109 is ended, the schedule setting processing illustrated in FIG. 2 is ended.

The description returns to the process of Step S107. When the desired date and time of the event included in the acquired schedule information overlaps with desired date and time of a confirmed schedule or a changeable schedule of the member participating in the event (Step S107: YES), the process proceeds to Step S110. In Step S110, the schedule setting server 20 executes a second adjustment process.

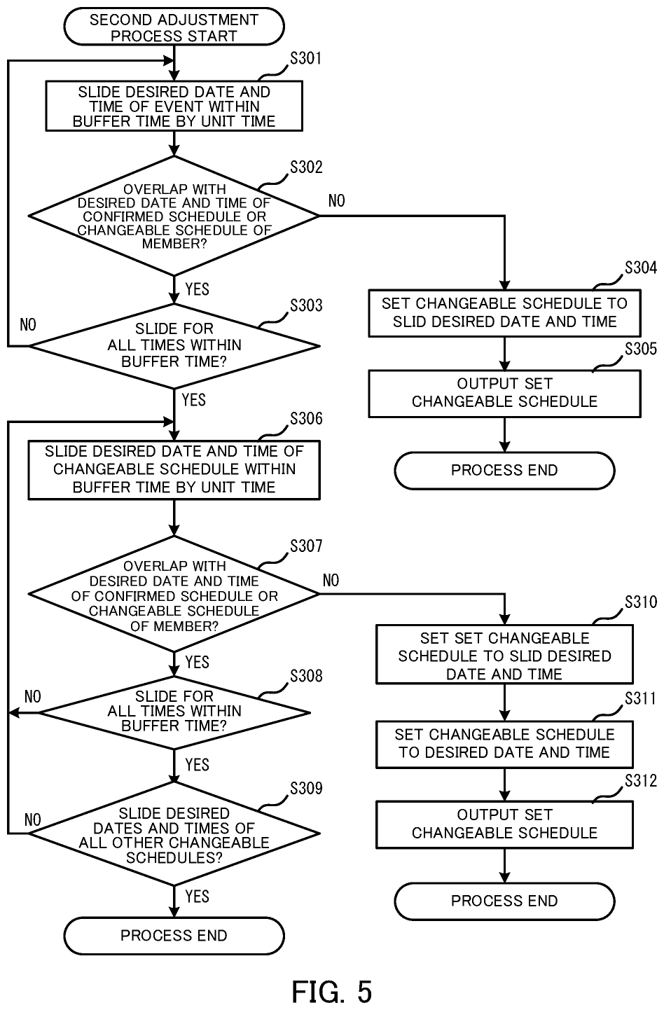

FIG. 5 is a diagram illustrating an example of a flowchart of the second adjustment process executed in Step S110 of FIG. 2.

When the desired date and time of the event included in the acquired schedule information overlaps with desired date and time of a confirmed schedule or a changeable schedule of a member participating in the event, the schedule setting server 20 executes the process of Step S301. In Step S301, the schedule setting server 20 slides the desired date and time of the event within a buffer time by a unit time (Step S301). For example, when the unit time is 30 minutes in an event in which 10:00 is set as the desired date and time, the schedule setting server 20 slides the desired date and time of the event from 10:00 to 10:30.

The schedule setting server 20 determines whether or not the slid desired date and time of the event overlaps with desired date and time of a confirmed schedule or a changeable schedule of a member participating in the event (Step S302).

When the slid desired date and time of the event overlaps with desired date and time of a confirmed schedule or a changeable schedule of a member participating in the event (Step S302: YES), the process proceeds to Step S303. That is, when the overlap between the desired date and time of the event and the desired date and time of the confirmed schedule or the changeable the schedule of member participating in the event is not eliminated even though the desired date and time of the event is slid within the buffer time by the unit time, the process proceeds to Step S303.

In Step S303, the schedule setting server 20 determines whether or not the desired date and time of the event has been slid for all the times within a buffer time of the event. For example, when the buffer time is set to two hours for an event in which 10:00 is set as the desired date and time, it is determined whether or not the desired date and time of the event has been slid for all the times within the buffer time from 8:00 to 12:00 for each unit time. When the desired date and time of the event has not been slid for all the times within the buffer time (Step S303: NO), the process returns to Step S301. That is, the processes of Steps S301 to S303 are repeatedly executed until the desired date and time of the event is slid for all the times within the buffer time or the overlap between the slid desired date and time of the event and the desired date and time of the confirmed schedule or the changeable schedule of the member participating in the event is eliminated.

When the slid desired date and time of the event does not overlap with desired date and time of a confirmed schedule or a changeable schedule of a member participating in the event (Step S302: NO), the process proceeds to Step S304.

The schedule setting server 20 sets a changeable schedule to the slid desired date and time (Step S304). That is, when the overlap between the desired date and time of the event and the desired date and time of the confirmed schedule or the changeable schedule of the member participating in the event is eliminated as a result obtained by sliding the desired date and time of the event within the buffer time by the unit time, the schedule setting server 20 sets a changeable schedule to the slid desired date and time.

The schedule setting server 20 outputs information on the set changeable schedule to the device 10 (Step S305). The schedule setting server 20 may output the information on the set changeable schedule to the device 10 owned by the member participating in the event. The device 10 acquires the information on the changeable schedule, which has been output from the schedule setting server 20. The device 10 displays the acquired information on the changeable schedule. The device 10 may display the acquired information on the changeable schedule only when logging in to device 10 with the account of the member participating in the event. The schedule setting server 20 may output the information on the set changeable schedule to the schedule setting server 20 itself or a device not illustrated in FIG. 1. When the overlap between the desired date and time of the event included in the schedule information and the desired date and time of the confirmed schedule or the changeable schedule of the member participating in the event is eliminated as a result obtained by sliding the desired date and time of the event, the schedule setting server 20 may output the information on the slid desired date and time of the event to the device 10. The schedule setting server 20 may output candidates for the slid desired date and time of the event to the device 10 as schedule candidates.

When the process of Step S305 is ended, the second adjustment process illustrated in FIG. 5 is ended. When the second adjustment process is ended, the schedule setting processing illustrated in FIG. 2 is also ended.

When the desired date and time of the event has been slid for all the times within the buffer time (Step S303: YES), the process proceeds to Step S306.

In Step S306, the schedule setting server 20 slides desired date and time of a changeable schedule within a buffer time by a unit time (Step S306).

The schedule setting server 20 determines whether or not the desired date and time of the event included in the acquired schedule information overlaps with desired date and time of a confirmed schedule or a changeable schedule of a member participating in the event (Step S307).

When the desired date and time of the event included in the acquired schedule information overlaps with desired date and time of a confirmed schedule or a changeable schedule of a member participating in the event (Step S307: YES), the process proceeds to Step S308. That is, when the overlap between the desired date and time of the event and the desired date and time of the confirmed schedule or the changeable schedule of the member participating in the event is not eliminated even though the desired date and time of the changeable schedule is slid within the buffer time by the unit time, the process proceeds to Step S308.

In Step S308, the schedule setting server 20 determines whether or not the desired date and time of the changeable schedule has been slid for all the times within the buffer time. When the desired date and time of the changeable schedule has not been slid for all the times within the buffer time (Step S308: NO), the process returns to Step S306. That is, the processes of Steps S306 to S308 are repeatedly executed until the desired date and time of the changeable schedule is slid for all the times within the buffer time or the overlap between the desired date and time of the event included in the acquired schedule information and the desired date and time of the confirmed schedule or the changeable schedule of the member participating in the event is eliminated.

When the desired date and time of the changeable schedule has been slid for all the times within the buffer time (Step S308: YES), the schedule setting server 20 determines whether or not desired dates and times of all the other changeable schedules have been slid (Step S309). When the desired dates and times of all the other changeable schedules have not been slid (Step S309: NO), the process returns to Step S306.

That is, the processes of Steps S306 to S309 are repeatedly executed until the desired dates and times of all the other changeable schedules are slid or the overlap between the desired date and time of the event included in the acquired schedule information and the desired date and time of the confirmed schedule or the changeable schedule of the member participating in the event is eliminated. When the desired dates and times of all the other changeable schedules have been slid (Step S309: YES), the second adjustment process illustrated in FIG. 5 is ended. When the second adjustment process is ended, the schedule setting processing illustrated in FIG. 2 is also ended.

When the desired date and time of the event included in the acquired schedule information does not overlap with desired date and time of a confirmed schedule or a changeable schedule of a member participating in the event (Step S307: NO), the process proceeds to Step S310.

The schedule setting server 20 sets the set changeable schedule to the slid desired date and time (Step S310). That is, when the overlap between the desired date and time of the event and the desired date and time of the confirmed schedule or the changeable schedule of the member participating in the event is eliminated as a result obtained by sliding the desired date and time of the changeable schedule within the buffer time by the unit time, the schedule setting server 20 sets the set changeable schedule to the slid desired date and time.

The schedule setting server 20 sets a changeable schedule to the desired date and time of the event (Step S311). That is, when the overlap between the desired date and time of the event included in the acquired schedule information and the slid desired date and time of the changeable schedule is eliminated, the schedule setting server 20 temporarily sets the event as a changeable schedule.

The schedule setting server 20 outputs information on the set changeable schedule to the device 10 (Step S312). The schedule setting server 20 may output the information on the set changeable schedule to the device 10 owned by the member participating in the event. The device 10 acquires the information on the changeable schedule, which has been output from the schedule setting server 20. The device 10 displays the acquired information on the changeable schedule. The device 10 may display the acquired information on the changeable schedule only when logging in to device 10 with the account of the member participating in the event. The schedule setting server 20 may output the information on the set changeable schedule to the schedule setting server 20 itself or a device not illustrated in FIG. 1.

When the overlap between the desired date and time of the event included in the schedule information and the desired date and time of the confirmed schedule or the changeable schedule of the member participating in the event is eliminated as a result obtained by sliding the desired date and time of the changeable schedule, the schedule setting server 20 may output the information on the slid desired date and time of the changeable schedule to the device 10. The schedule setting server 20 may output candidates for the slid desired date and time of the changeable schedule to the device 10 as schedule candidates.

When the process of Step S312 is ended, the second adjustment process illustrated in FIG. 5 is ended. When the second adjustment process is ended, the schedule setting processing illustrated in FIG. 2 is also ended.

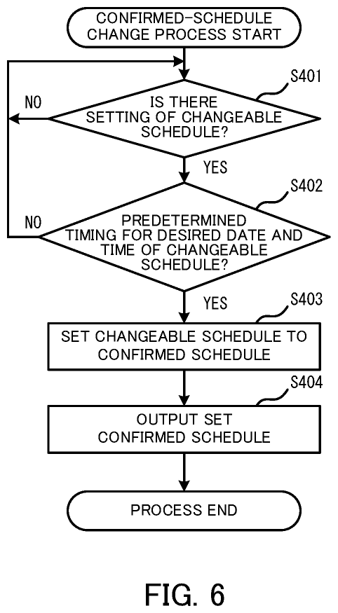

FIG. 6 is a diagram illustrating an example of a flowchart of a confirmed-schedule setting process by a schedule setting method according to an embodiment. The confirmed-schedule setting process in FIG. 6 is executed separately and independently from the schedule setting processing described with reference to FIG. 2. The confirmed-schedule setting process may be executed in parallel with the schedule setting processing in FIG. 2. The confirmed-schedule setting process may be executed in series with the schedule setting processing in FIG. 2. The confirmed-schedule setting process in FIG. 6 may be repeatedly executed at each preset timing.

First, the schedule setting server 20 determines whether or not there is a setting of a changeable schedule of any member (Step S401). When a changeable schedule is not set (Step S401: NO), the process stands by until a changeable schedule is set.

When there is the setting of the changeable schedule (Step S401: YES), the schedule setting server 20 determines whether or not it is a predetermined timing for the desired date and time of the changeable schedule (Step S402). The schedule setting server 20 may determine whether or not it is a day before the desired date and time of the changeable schedule. The schedule setting server 20 may determine whether or not it is a predetermined time and minute of the day before the desired date and time of the changeable schedule. The schedule setting server 20 may determine, as the predetermined timing, a time when a predetermined time has elapsed after the changeable schedule has been set.

When it is not the predetermined timing for the desired date and time of the changeable schedule (Step S402: NO), the process returns to Step S401, and the processes of Steps S401 and S402 are repeatedly executed until the predetermined timing for the desired date and time of the changeable schedule.

When it is the predetermined timing for the desired date and time of the changeable schedule (Step S402: YES), the schedule setting server 20 sets the changeable schedule as a confirmed schedule (Step S403).

The schedule setting server 20 outputs the information on the confirmed schedule changed in Step S403 to the device 10 (Step S404). The schedule setting server 20 may output the information on the changed confirmed schedule to the device 10 owned by the member participating in the event. The device 10 acquires the information on the confirmed schedule, which has been output from the schedule setting server 20. The device 10 displays the acquired information on the confirmed schedule. The device 10 may display the acquired information on the confirmed schedule only when logging in to device 10 with the account of the member participating in the event. The schedule setting server 20 may output the information on the changed confirmed schedule to the schedule setting server 20 itself or a device not illustrated in FIG. 1. When the process of Step S404 is ended, the confirmed-schedule setting process is ended.

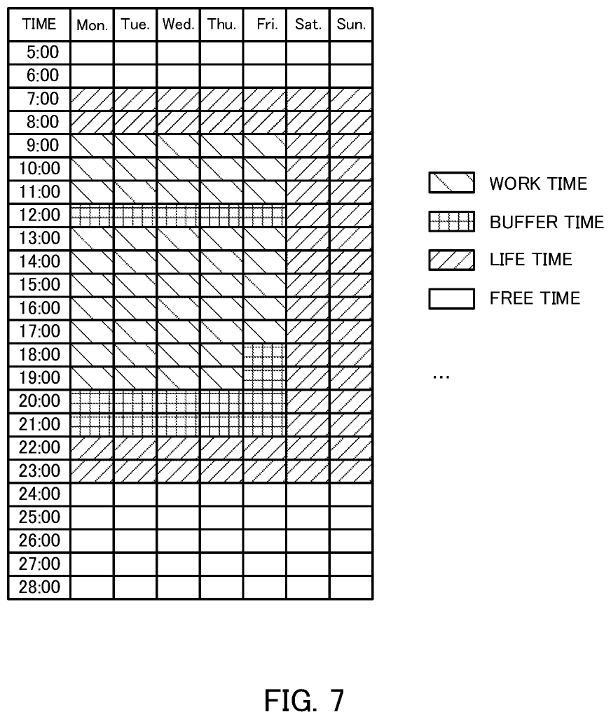

FIG. 7 is a diagram illustrating an example of a schedule of a member participating in an event. In the present example, the schedule SA of the member MA participating in an event is set. Information on the schedule SA of the member MA is set in the schedule setting server 20.

A time slot corresponding to the attribute set for

a schedule A is as follows.
Work time: 9:00 to 12:00 and 13:00 to 20:00 on Monday to Thursday
   9:00 to 12:00 and 13:00 to 18:00 on Friday
Buffer time: 12:00 to 13:00 and 20:00 to 22:00 on Monday to Thursday
   12:00 to 13:00 and 18:00 to 22:00 on Friday
Life time: 7:00 to 9:00 and 22:00 to 24:00 on Monday to Friday
   7:00 to 24:00 on Saturday and Sunday
Free time: 24:00 to 6:00 on Monday to Sunday

A time slot corresponding to the attribute set for a schedule B is as follows.
Work time: 9:00 to 12:00 and 13:00 to 20:00 on Monday to Thursday
   9:00 to 12:00 and 13:00 to 18:00 on Friday
Buffer time: 12:00 to 13:00 and 20:00 to 22:00 on Monday to Thursday
   12:00 to 13:00 and 18:00 to 22:00 on Friday
Life time: 7:00 to 9:00 and 22:00 to 24:00 on Monday to Friday
   7:00 to 24:00 on Saturday and Sunday
Free time: 24:00 to 6:00 on Monday to Sunday

The work time is a work time of the member. The life time is a hobby time of the member. The buffer time is a time of either work or hobby of the member. As the buffer time, either work or hobby may be selected based on the intention of the member. The free time is a sleeping time of the member.

The schedule setting server 20 can set a confirmed schedule and a changeable schedule to the work time. It is not possible for the schedule setting server 20 to set a confirmed schedule and a changeable schedule to the life time. The schedule setting server 20 may set a confirmed schedule and a changeable schedule to the buffer time. Whether or not to set a confirmed schedule and a changeable schedule to the buffer time may be set based on selection of the member.

Although not illustrated in FIG. 7, schedules of other members participating in the same event are also set in the schedule setting server 20 in a similar manner to the manner for the schedule SA. In the schedule setting server 20, a different schedule is set for each member. The work time, the buffer time, the life time, and the free time may be set to different time slots for each member. The work time, the buffer time, the life time, and the free time may be set to the same time slot for each member.

Each time slot of the work time, the buffer time, the life time, and the free time may be individually set by each member. In addition, the setting of a holiday may be provided in the work time, the buffer time, the life time, and the free time in addition to the setting of Monday to Sunday. The setting of the holiday can be made to be the same as the setting of Saturday or Sunday.

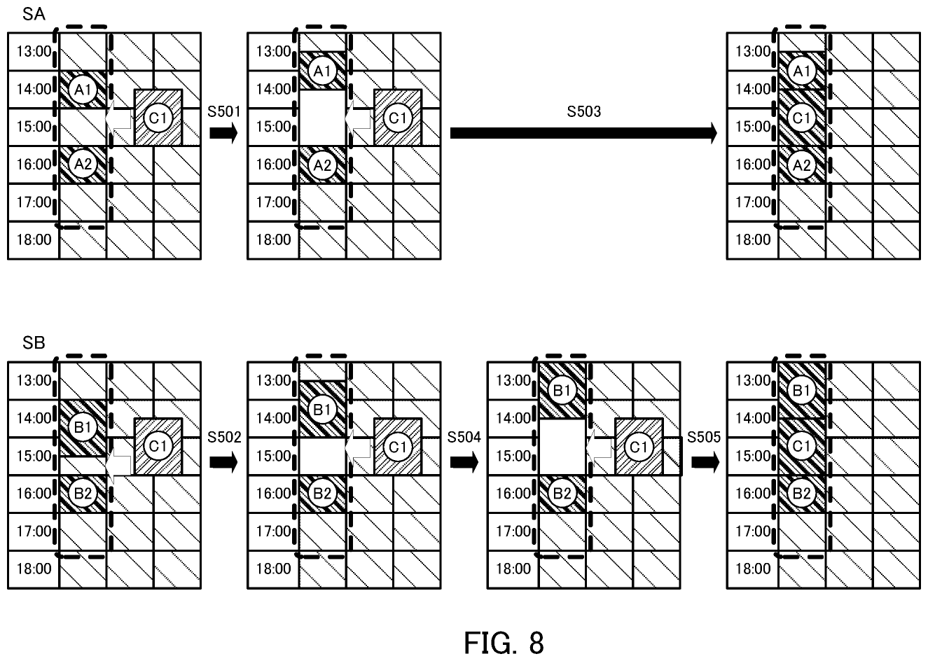

Next, an example of setting a changeable schedule of a member participating in the event will be described. FIG. 8 is a diagram illustrating an example in which desired date and time of a set changeable schedule are set again by being slid. In the example of FIG. 8, an example of setting changeable schedules in a schedule SA of a member MA participating in an event C1 and a schedule SB of a member MB participating in the event C1 will be described.

A changeable schedule A1 and a changeable schedule A2 are set in the schedule SA of the member MA. The desired date and time of the changeable schedule A1 is set to 14:00 to 15:00, and the desired date and time of the changeable schedule A2 is set to 16:00 to 17:00. A changeable schedule B1 and a changeable schedule B2 are set in the schedule SB of the member MB. The desired date and time of the changeable schedule B1 is set to 14:00 to 15:30, and the desired date and time of the changeable schedule B2 is set to 16:00 to 17:00. The buffer times of the changeable schedule A1 and the changeable schedule B1 are set to 13:00 to 18:00, respectively.

A case where the type of the event C1 included in new schedule information acquired from the device 10 by the schedule setting server 20 is fixed, and the desired date and time of the event C1 in which the working time is 1 hour 30 minutes is 14:30 to 16:00 will be described.

The desired date and time 14:30 to 16:00 of the event C1 overlaps with the desired date and time 14:00 to 15:00 of the changeable schedule A1. Similarly, the desired date and time 14:30 to 16:00 of the event C1 overlaps with the desired date and time 14:00 to 15:30 of the changeable schedule B1.

Therefore, the schedule setting server 20 slides the desired date and time 14:00 to 15:00 of the changeable schedule A1 to 13:30 to 14:30 by 30 minutes so that the event C1 can be set at the desired date and time 14:30 to 16:00 (Step S501). The slidable time is within the buffer time 13:00 to 18:00 of the changeable schedule A1.

Similarly, the schedule setting server 20 slides the desired date and time 14:00 to 15:30 of the changeable schedule B1 to 13:30 to 15:00 by 30 minutes so that the event C1 can be set at the desired date and time 14:30 to 16:00 (Step S502). The slidable time is within the buffer time 13:00 to 18:00 of the changeable schedule B1.

The slid desired date and time 13:30 to 14:30 of the changeable schedule A1 does not overlap with the desired date and time 14:30 to 16:00 of the event C1. That is, when the overlap between the desired date and time of the changeable schedule A1 and the desired date and time of the event C1 is eliminated as a result obtained by the sliding, the schedule setting server 20 sets the set changeable schedule A1 to the slid desired date and time 13:30 to 14:30 (Step S503).

Unlike the slid changeable schedule A1, the slid desired date and time 13:30 to 15:00 of the changeable schedule B1 still overlaps with the desired date and time 14:30 to 16:00 of the event C1. Therefore, the schedule setting server 20 further slides the slid desired date and time 13:30 to 15:00 of the changeable schedule B1 to 13:00 to 14:30 by 30 minutes (Step S504).

The slid desired date and time 13:00 to 14:30 of the changeable schedule B1 does not overlap with the desired date and time 14:30 to 16:00 of the event C1. That is, when the overlap between the slid desired date and time of the changeable schedule B1 and the desired date and time of the event C1 is eliminated, the schedule setting server 20 sets the set changeable schedule A1 at the slid desired date and time 13:00 to 14:30 (Step S505).

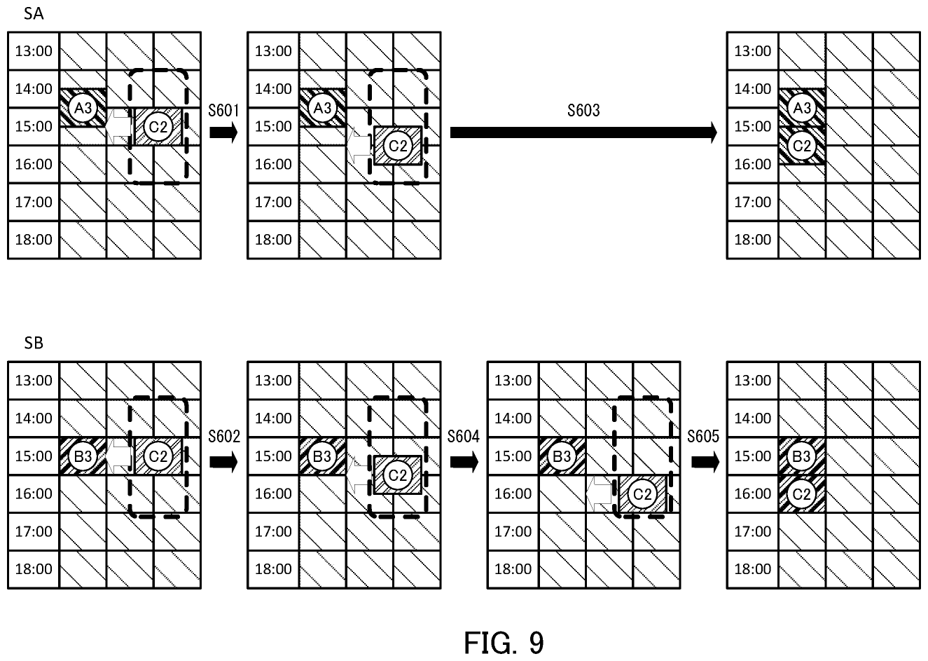

FIG. 9 is a diagram illustrating an example in which desired date and time of a changeable schedule is set by sliding desired date and time of an event. In the example of FIG. 9, an example of setting changeable schedules in a schedule SA of a member MA participating in an event C2 and a schedule SB of a member MB participating in the event C2 will be described.

A changeable schedule A3 is set in the schedule SA of the member MA. The desired date and time of the changeable schedule A3 is set to 14:30 to 15:30. A changeable schedule B3 is set in the schedule SB of the member MB. The desired date and time of the changeable schedule B3 is set to 15:00 to 16:00. The buffer time for the event C2 is set to 14:00 to 17:00.

A case where the type of the event C2 included in new schedule information acquired from the device 10 by the schedule setting server 20 is fixed, and the desired date and time of the event C2 in which the working time is 1 hour is 15:00 to 16:00 will be described.

The desired date and time 15:00 to 16:00 of the event C2 overlaps with the desired date and time 14:30 to 15:30 of the changeable schedule A3. Similarly, the desired date and time 15:00 to 16:00 of the event C2 overlaps with the desired date and time 15:00 to 16:00 of the changeable schedule B3.

Therefore, the schedule setting server 20 slides the desired date and time 15:00 to 16:00 of the event C2 to 15:30 to 16:30 by 30 minutes so that the event C2 can be set (Step S601). The slidable time is within the buffer time 14:00 to 17:00 of the event C2.

Similarly, the schedule setting server 20 slides the desired date and time 15:00 to 16:00 of the event C2 to 15:30 to 16:00 by 30 minutes so that the event C2 can be set (Step S602). The slidable time is within the buffer time 14:00 to 17:30 of the event C2.

The slid desired date and time 15:30 to 16:30 of the event C2 does not overlap with the desired date and time 14:30 to 15:30 of the changeable schedule A3. That is, when the overlap between the desired date and time of the event C2 and the desired date and time of the changeable schedule A3 is eliminated as a result obtained by the sliding, the schedule setting server 20 sets a changeable schedule A4 of the event C2 to the slid desired date and time 15:30 to 16:30 (Step S603).

Unlike the changeable schedule A2, the slid desired date and time 15:30 to 16:30 of the event C2 still overlaps with the desired date and time 15:00 to 16:00 of the changeable schedule B3. Therefore, the schedule setting server 20 further slides the slid desired date and time 15:30 to 16:30 of the event C2 to 16:00 to 17:00 by 30 minutes (Step S604).

The slid desired date and time 16:00 to 17:00 of the event C2 does not overlap with the desired date and time 15:00 to 16:00 of the changeable schedule B3. That is, when the overlap between the slid desired date and time of the event C2 and the desired date and time of the changeable schedule B3 is eliminated, the schedule setting server 20 sets the changeable schedule A4 of the event C2 to the slid desired date and time 16:00 to 17:00 (Step S605).

According to the embodiment described above, for example, when the desired date and time of the event overlaps with desired date and time of a confirmed schedule or a changeable schedule of a member participating in the event, the desired date and time of the event or the desired date and time of the changeable schedule is slid within a buffer time set in advance by a unit time. the changeable schedule is automatically set at the slid desired date and time. Thus, even when the desired date and time of the event overlaps with the desired date and time of the confirmed schedule or the changeable schedule of the member, the changeable schedule is automatically reset. Therefore, it is possible to easily perform re-scheduling of a member participating in an event, and to quickly set the schedule of the member participating in the event.

It is also possible to re-adjust desired date and time of an event or a changeable schedule in units of unit time (for example, “15 minutes”). As a result, it is possible to set a new schedule to a schedule of a member having no vacant time at a glance. Therefore, for example, even in an event of a regular meeting set to the same desired date and time every week, it is possible to set the event without being bound to the same time every week and without disturbing other schedules.

In addition, even when desired date and time of a changeable schedule overlaps with the desired date and time of the newly acquired event, the desired date and time of the changeable schedule is re-adjusted in accordance with a predetermined buffer time, and thus, it is possible to shorten the re-adjustment man-hours of a schedule due to the entry of another event. In addition, the desired date and time of the event is re-adjusted in accordance with a predetermined buffer time even when the desired date and time of the event overlaps with desired date and time of another changeable schedule. Thus, it is possible to shorten the re-adjustment man-hours of a schedule due to the entry of another event.

### Another Embodiment

The schedule setting server 20 in the present embodiment can also quickly set a schedule of a member participating in an event by the configuration as follows.

That is, the schedule setting server 20 acquires schedule information in a list format inputtable by a member. As the list format, for example, a ToDo list can be adopted. The list format is not limited to the ToDo list, and may be a format in which task management can be performed. The ToDo list may be, for example, in the list format displayed as schedule information of the user, which has been input to the device 10.

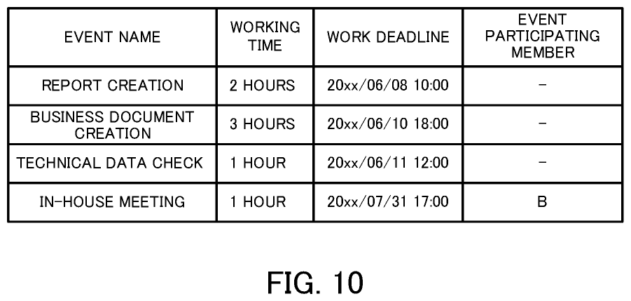

FIG. 10 is a diagram illustrating an example of receiving schedule information in a list format. In FIG. 10, the schedule information is received in a ToDo list as the list format. FIG. 10 illustrates, for example, schedule information of the member A. The schedule information illustrated in FIG. 10 includes information including the name of the event (event name), the working time, the work deadline, and members participating in the event (event participating member). The schedule information received in the ToDo list may include other types of information not illustrated in FIG. 10.

Information on members participating in the event together with the member A is input in the field of the members participating in the event. For example, in the event of the “in-house meeting” in FIG. 10, information on the member B is received as the information on the member participating in the event together.

In this case, the schedule setting server 20 sets a changeable schedule of the event to the desired date and time having a high priority among dates and times that do not overlap with desired dates and times of confirmed schedules or changeable schedules of the members A and B. The schedule setting server 20 may set a changeable schedule of the event having the earliest desired date and time as the desired date and time having a high priority among dates and times that do not overlap with desired dates and times of confirmed schedules or changeable schedules of the members A and B.

As a result, it is possible to set a schedule for both the member A and the member B at the earliest timing. In this case, a buffer time can be set from the reception of the schedule information to the work deadline. The work deadline is set in the embodiment of FIG. 10, but the present disclosure is not limited thereto. For example, when the work deadline is not set, the buffer time can be set such that the end time is not set after the schedule information is received. As a result, it is possible to maximize the buffer time and to easily set the schedules of the members.

In addition, the schedule setting server 20 acquires information on the desired date and time of the event as information on any date and time. The schedule setting server 20 can designate, for example, date and time that does not overlap with desired date and time of a confirmed schedule or a changeable schedule of a member without designating the date and time as any date and time.

When the desired date and time of the event included in the schedule information overlaps with desired date and time of a confirmed schedule or a changeable schedule of a member participating in the event, the schedule setting server 20 determines whether or not there is overlap with the desired date and time of the confirmed schedule or the changeable schedule of the member. Then, when there is the overlap with the desired date and time of the confirmed schedule or the changeable schedule of the member participating in the event, the schedule setting server 20 may set a changeable schedule to the desired date and time having a high priority among dates and times that do not overlap with desired dates and times of confirmed schedules or changeable schedules of the members. In this case, the schedule setting server 20 may set, as the desired date and time having a high priority, the earliest desired date and time among dates and times at which the desired date and time of the event does not overlap with desired dates and times of confirmed schedules or changeable schedules of the members participating in the event.

As a result, it is possible to automatically set the event at a time when the members are free (a free time) without the need to set desired date and time each time, and to quickly set the schedule of the members participating in the event.

In the embodiment of FIG. 10, the working time of one event is set by one time, but the present disclosure is not limited thereto. For example, the working time of one event may be divided into a plurality of unit times.

Specifically, the working time of an event of the event “report creation” in FIG. 10 is set to “2 hours”, but this working time may be divided into unit times of every 1 hour. In this case, the working time “2 hours” of the event “report creation” is divided into two times of “1 hour” and “1 hour”. The work time “2 hours” of the event of the event “report creation” may be divided into four unit times of every 30 minutes. The unit time can be set in advance for each hour and minute. By dividing the working time of the event, it is possible to flexibly designate the date and time that does not overlap with desired dates and times of confirmed schedules or changeable schedules of the members.

### Configuration of Device

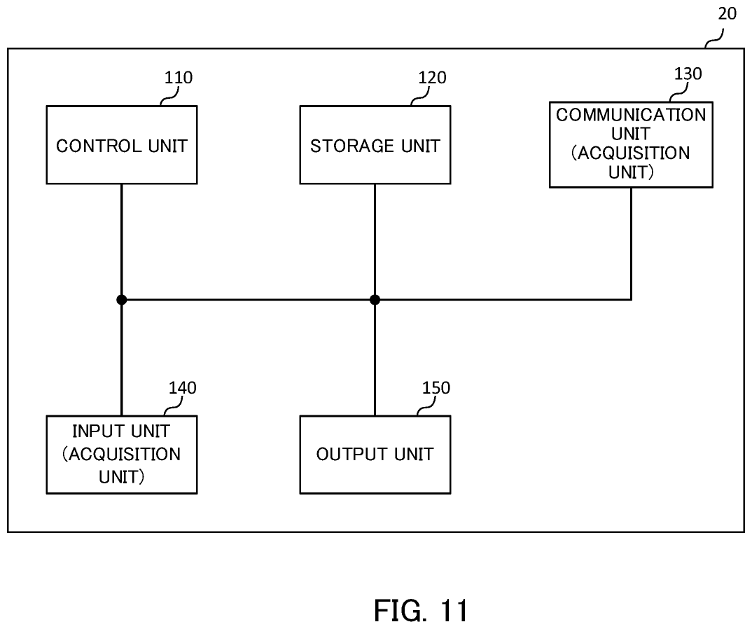

FIG. 11 is a diagram illustrating an example of a functional configuration of a schedule setting server according to another embodiment. As illustrated in the present example, a schedule setting server 20 includes a control unit 110, a storage unit 120, a communication unit 130, an input unit 140, and an output unit 150. In the present example, functional blocks of feature parts in the present embodiment are mainly illustrated, and the device 10 may also have other functional blocks necessary for other processes. In addition, a configuration not including some functional blocks may be employed.

The control unit 110 controls the device 10. The control unit 110 can be configured by a controller, a control circuit, or a control device described based on common recognition in the technical field according to the present disclosure.

The storage unit 120 stores (saves) information used in the device 10. The storage unit 120 can be configured by, for example, a memory, a storage, a storage device, and the like described based on common recognition in the technical field according to the present disclosure.

The communication unit 130 communicates with another communication device (a device, a server, and the like) via a network. The communication unit 13 may output the received various types of information to the control unit 110.

The communication unit 130 can be configured by a transmitter/receiver, a transmission and reception circuit, or a transmission and reception device described based on common recognition in the technical field according to the present disclosure. The communication unit 130 may include a transmission unit and a communication unit.

The input unit 140 receives an input by the operation from the user. Furthermore, the input unit 140 may be connected to a predetermined device, a storage medium, or the like and receive an input of data. The input unit 140 may output the input result to the control unit 110, for example.

The input unit 140 can be configured by an input device (such as a keyboard, a mouse, and a button), an input and output terminal, an input and output circuit, and the like described based on common recognition in the technical field according to the present disclosure. Furthermore, the input unit 140 may be configured to be integrated with a display unit (for example, a touch panel).

The output unit 150 outputs data, contents, and the like in a format perceptible to the user. For example, the output unit 150 may be configured to include a display unit that displays an image, a sound output unit that outputs sound, and the like.

The display unit can be configured by, for example, a display device such as a display or a monitor described based on common recognition in the technical field according to the present disclosure. Furthermore, the sound output unit can be configured by an output device such as a speaker described based on common recognition in the technical field according to the present disclosure.

The output unit 150 can be configured to include, for example, an arithmetic unit, an arithmetic circuit, an arithmetic device, a player, an image/video/sound processing circuit, an image/video/sound processing device, an amplifier, and the like described based on common recognition in the technical field according to the present disclosure.

Any one of or a combination of the communication unit 130, the input unit 140, and the control unit 110 may be referred to as an acquisition unit. The acquisition unit may acquire schedule information including information on the members participating in an event, information on the desired date and time of the event, and information on the type of event.

The control unit 110 may perform processing based on the steps illustrated in FIGS. 2 to 6.

The device 10 may also have a configuration similar to that of FIG. 11. A person skilled in the related art can appropriately read and understand the description related to the schedule setting server 20 in the explanation of FIG. 11.

Some parts will be exemplarily described below. The reference sign of each device corresponding to each functional block in FIG. 11 is represented by applying the first single-digit number (for example, “2” of the first single digit of “20” in the case of the schedule setting server 20) of the reference sign indicating each device to the first single-digit number in the figure.

The communication unit 230 in the schedule setting server 20 may acquire, from the device 10, the schedule information including the information on the members participating in the event, the information on the desired date and time of the event, and the information on the type of the event. The control unit 210 in the schedule setting server 20 may set a schedule including a confirmed schedule or a changeable schedule based on the schedule information.

When the type of the event is the first type (fixed type) and the desired date and time of the event included in the schedule information does not overlap with desired date and time of a confirmed schedule of a member participating in the event, the control unit 210 in the schedule setting server 20 may set a confirmed schedule to the desired date and time included in the schedule information. When the type of the event is the second type (semi-fixed type) and the desired date and time of the event included in the schedule information does not overlap with desired date and time of a confirmed schedule or a changeable schedule of a member participating in the event, the control unit 210 in the schedule setting server 20 may set a changeable schedule to the desired date and time.

When the desired date and time of the event included in the schedule information overlaps with desired date and time of a confirmed schedule or a changeable schedule of a member participating in the event, the control unit 210 in the schedule setting server 20 may slide the desired date and time of the event or the desired date and time of the changeable schedule within a buffer time set in advance by a unit time. When the overlap between the desired date and time of the event included in the schedule information and the desired date and time of the confirmed schedule or the changeable schedule of the member participating in the event is eliminated as a result obtained by sliding the desired date and time of the event or the desired date and time of the changeable schedule, the control unit 210 in the schedule setting server 20 may set a changeable schedule to the slid desired date and time.

The control unit 210 in the schedule setting server 20 may set the changeable schedule as a confirmed schedule of the desired date and time at a predetermined timing.

When the type of the event is the first type, and the desired date and time of the event included in the schedule information overlaps with desired date and time of a changeable schedule of a member participating in the event, the control unit 210 in the schedule setting server 20 may slide the overlapping desired date and time of the changeable schedule within a buffer time by a unit time. When the overlap between the desired date and time of the event and desired date and time of a confirmed schedule or a changeable schedule of a member participating in the event is eliminated as a result obtained by sliding the desired date and time of the changeable schedule, the control unit 210 in the schedule setting server 20 may set a changeable schedule to the slid desired date and time.

When the type of the event is the second type, and the desired date and time of the event included in the schedule information overlaps with desired date and time of a confirmed schedule or a changeable schedule of a member participating in the event, the control unit 210 in the schedule setting server 20 may slide the desired date and time of the event within a buffer time set in advance by a unit time. When the overlap between the desired date and time of the event and the desired date and time of the confirmed schedule or the changeable schedule of the member participating in the event is eliminated as a result obtained by sliding the desired date and time of the event, the control unit 210 in the schedule setting server 20 may set a changeable schedule to the slid desired date and time.

When the type of the event is the second type, and the desired date and time of the event included in the schedule information overlaps with desired date and time of a confirmed schedule or a changeable schedule of a member participating in the event, the control unit 210 in the schedule setting server 20 may slide the desired date and time of the event within a buffer time set in advance for the event, by a unit time. When the overlap between the desired date and time of the event and the desired date and time of the changeable schedule of the member participating in the event is not eliminated as a result obtained by sliding the desired date and time of the event within the buffer time set in advance for the event, the control unit 210 in the schedule setting server 20 may slide the overlapping desired date and time of the changeable schedule within a buffer time set in advance for the changeable schedule by a unit time. When the overlap between the desired date and time of the event and the desired date and time of the confirmed schedule or the changeable schedule of the member participating in the event is eliminated as a result obtained by sliding the desired date and time of the changeable schedule, the control unit 210 in the schedule setting server 20 may set a changeable schedule to the slid desired date and time.

When the overlap between the desired date and time of the event included in the schedule information and the desired date and time of the confirmed schedule or the changeable schedule of the member participating in the event is eliminated as a result obtained by sliding the desired date and time of the event or the desired date and time of the changeable schedule, the output unit 150 in the schedule setting server 20 may output information on the slid desired date and time.

The output unit 150 in the schedule setting server 20 may output candidates for the slid desired date and time as schedule candidates. The control unit 210 in the schedule setting server 20 may set desired date and time of a schedule candidate selected from the output schedule candidates, as the desired date and time of the changeable schedule.

In the above-described embodiment, when the type of a new event is semi-fixed and there is an overlap with desired date and time of a confirmed schedule or a changeable schedule (Step S107: YES), the schedule setting server 20 first slides the desired date and time of the event within a buffer time by a unit time (Step S301), but the present disclosure is not limited thereto. For example, when a priority flag is set in advance, the schedule setting server 20 may preferentially slide the desired date and time of the existing changeable schedule within a buffer time by a unit time (Step S306). The priority flag can be freely set based on the operation of the user. In this case, when the second adjustment process executed in Step S110 of FIG. 2 is executed, the processes in Steps S306 to S312 are executed, and then the processes in Steps S301 to S305 are executed. Therefore, it is possible to freely change the schedule to be preferentially slid, based on the setting of the priority flag.

### Hardware Configuration

The block diagrams used in the description of the above embodiments illustrate blocks in units of functions. The functional blocks (components) are realized by any combination of hardware and/or software. In addition, means for realizing each functional block is not particularly limited. That is, each functional block may be realized by one physically-coupled device, or may be realized by a plurality of devices in which two or more physically-separated devices are connected by wire or wirelessly.

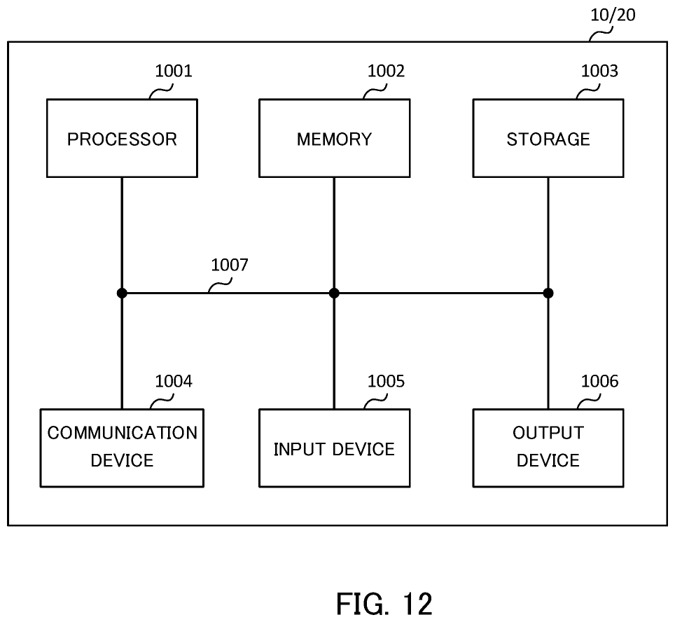

For example, an apparatus (such as the schedule setting server 20) in the embodiment of the present disclosure may function as a computer that performs processing of the schedule setting method in the present disclosure. FIG. 12 is a diagram illustrating an example of a hardware configuration of a schedule setting server and the like according to an embodiment. The device 10, the schedule setting server 20, and the like described above may be physically configured as a computer device including a processor 1001, a memory 1002, a storage 1003, communication device 1004, an input device 1005, an output device 1006, a bus 1007, and the like.

In the present disclosure, an apparatus, a circuit, a device, a unit, a server, and the like can be replaced with each other. The hardware configuration of the device 10, the schedule setting server 20, and the like may be configured to include one or a plurality of devices illustrated in the drawings, or may be configured without including some devices.

For example, although only one processor 1001 is illustrated, there may be a plurality of processors. Furthermore, the processing may be performed by one processor, or the processing may be performed simultaneously, sequentially, or with other methods by two or more processors. The processor 1001 may be implemented by one or more chips.

Each function in the device 10, the schedule setting server 20, and the like is realized in a manner that predetermined software (program) is read on hardware such as the processor 1001 and the memory 1002, and thereby the processor 1001 performs an arithmetic operation and controls communication by the communication device 1004, reading and/or writing of data in the memory 1002 and the storage 1003, and the like.

The processor 1001 controls the entirety of the computer by operating an operating system, for example. The processor 1001 may be configured by a central processing unit (CPU) including an interface with a peripheral device, a control device, an arithmetic device, a register, and the like. Each unit such as the above-described control unit 110 may be realized by the processor 1001.

In addition, the processor 1001 may control the entirety of the computer by a method of searching for the minimum value (global minimum) of any objective function from any set of solution candidates with a process using quantum fluctuation by a quantum annealing method (quantum annealing). This makes it possible to largely shorten the time required for resetting the schedule.

In addition, the processor 1001 reads a program (program codes), a software module, data, and the like from at least one of the storage 1003 and the communication device 1004 to the memory 1002, and executes various processes according to the read program, software module, data, or the like. As the program, a program for causing a computer to execute at least some of the operations described in the above-described embodiments is used. For example, the control unit 110 may be realized by a control program that is stored in the memory 1002 and operated in the processor 1001, and other functional blocks may be similarly realized.

The memory 1002 is a computer-readable recording medium, and may be configured by, for example, at least one of a ROM (Read Only Memory), an EPROM (Erasable Programmable ROM), an EEPROM (Electrically EPROM), a RAM (Random Access Memory), or other appropriate storage media. The memory 1002 may be referred to as a register, a cache, a main memory (main storage device), or the like. The memory 1002 may store a program (program codes), a software module, and the like that can be executed to implement the method according to the embodiment.

The storage 1003 is a computer-readable recording medium, and may be configured by, for example, at least one of a flexible disk, a Floppy (registered trademark) disk, a magneto-optical disk (for example, a compact disc (such as a CD-ROM (Compact Disc ROM)), a digital versatile disc, or a Blu-ray (registered trademark) disc), a removable disk, a hard disk drive, a smart card, a flash memory device (for example, a card, a stick, or a key drive), a magnetic stripe, a database, a server, or other appropriate storage media. The storage 1003 may be referred to as an auxiliary storage device. The above-described storage unit 120 may be realized by the memory 1002 and/or the storage 1003.

The communication device 1004 is hardware (transmission and reception device) for performing communication between computers via at least one of a wired network and a wireless network. The communication device 1004 is also referred to as, for example, a network device, a network controller, a network card, a communication module, or the like. The communication device 1004 may include a SIM card (Subscriber Identity Module Card). The above-described communication unit 130 may be realized by the communication device 1004.

The input device 1005 is an input device (for example, a keyboard, a mouse, and the like) that receives an input from the outside. The output device 1006 is an output device (for example, a display, a speaker, and the like) that performs an output to the outside. The input device 1005 and the output device 1006 may be integrated (for example, a touch panel). The input unit 140 and the output unit 150 described above may be realized by the input device 1005 and the output device 1006, respectively.

In addition, each device such as the processor 1001 and the memory 1002 is connected by a bus 1008 for transmitting and receiving information. The bus 1007 may be configured by a single bus or may be configured by different buses between devices.

Furthermore, the schedule setting server 20 and the like may be configured to include hardware such as a microprocessor, a digital signal processor (DSP), an ASIC (Application Specific Integrated Circuit), a PLD (Programmable Logic Device), and an FPGA (Field Programmable Gate Array), and some or all of the functional blocks may be realized by the hardware. For example, the processor 1001 may be implemented by at least one of the pieces of hardware.

### Modification Examples

The terms described in the present disclosure and/or terms necessary for understanding the present disclosure may be replaced with terms having the same or similar meanings.

The information, the parameter, and the like described in the present disclosure may be represented by using an absolute value, may be represented by using a relative value from a predetermined value, or may be represented by using another corresponding information. In addition, names used for parameters and the like in the present disclosure are not limited in any respect.

The information, the signals, and the like described in the present disclosure may be represented by using any of various different techniques. For example, data, instructions, commands, information, signals, bits, symbols, chips, and the like that may be mentioned throughout the above description may be represented by voltages, currents, electromagnetic waves, magnetic fields or magnetic particles, optical fields or photons, or any combination thereof.

Information, signals, and the like may be input and output via a plurality of network nodes. The input or output information, signals, and the like may be stored in a specific location (for example, memory) or may be managed by using a table. The input or output information, signals, and the like can be overwritten, updated, or added. The output information, signals, and the like may be deleted. The input information, signal, and the like may be transmitted to another device.

Regardless of whether software is referred to as software, firmware, middleware, microcode, a hardware description language, or is referred to as other names, the software should be construed broadly to mean instructions, instruction sets, codes, code segments, program codes, programs, subprograms, software modules, applications, software applications, software packages, routines, subroutines, objects, executable files, execution threads, procedures, functions, and the like.

Software, instructions, information, and the like may be transmitted and received via at least one of a transmission medium and a signal waveform. For example, when software is transmitted from a website, server, or another remote source by using at least one of a wired technique (a coaxial cable, an optical fiber cable, a twisted pair, a digital subscriber line (DSL), or the like.) and a wireless technology (infrared rays, microwaves, and the like), at least one of the wired technique and the wireless technique is included within the definition of the transmission medium.

The terms “system” and “network” used in the present disclosure may be used interchangeably.

Each aspect/embodiment described in the present disclosure may be used alone, or may be used in combination, or may be switched with execution. In addition, the order of the processing procedure, the sequence, the flowchart, and the like in each aspect/embodiment described in the present disclosure may be changed as long as there is no contradiction. For example, for the methods described in the present disclosure, elements of various steps are presented by using an exemplary order, and are not limited to the specific order presented.

The description “based on” used in the present disclosure does not mean “based only on” unless explicitly stated otherwise. In other words, the description “based on” means both “based only on” and “based at least on”.

Any reference to elements using designations such as “first” and “second” used in the present disclosure does not generally limit the amount or order of the elements. The designations may be used in the present disclosure as a convenient method for distinguishing between two or more elements. Thus, the reference to the first and second elements does not mean that only two elements may be adopted or that the first element must precede the second element in any form.

When the terms “include”, “including”, variations thereof are used in the present disclosure, the terms are intended to be inclusive in a manner similar to the term “comprising”. Furthermore, the term “or” used in the present disclosure is intended not to be an exclusive OR.

In the present disclosure, for example, when articles such as a, an, and the in English are added by translation, the present disclosure may include a case where a noun following these articles has a plural form.

Hitherto, the invention according to the present disclosure has been described in detail above, but it is apparent to those skilled in the related art that the invention according to the present disclosure is not limited to the embodiments described in the present disclosure. The invention according to the present disclosure can be performed as modifications and changes without departing from the spirit and scope of the invention defined based on the description of the claims. Therefore, the description of the present disclosure is made for the purpose of exemplary description and does not bring any restrictive meaning to the invention according to the present disclosure.

The present application is based on Japanese Patent Application No. 2021-065861 filed on Apr. 8, 2021. The contents of this application are all incorporated herein.

### EXPLANATION OF REFERENCE SIGNS

1 Schedule setting system
10 Device
13 Communication unit
20 Schedule setting server
110 Control unit
120 Storage unit
130 Communication unit
140 Input unit
150 Output unit
210 Control unit
230 Communication unit
1001 Processor
1002 Memory
1003 Storage
1004 Communication device
1005 Input device
1006 Output device
1007 Bus
1008 Bus

1. A schedule setting system comprising:
an acquisition unit that acquires schedule information including information on a member participating in an event, information on desired date and time of the event, and information on a type of the event; and
a control unit that sets a schedule including a confirmed schedule or a changeable schedule based on the schedule information, wherein
the control unit
sets a confirmed schedule to the desired date and time included in the schedule information when the type of the event is a first type, and the desired date and time of the event included in the schedule information does not overlap with desired date and time of a confirmed schedule of the member participating in the event,
sets a changeable schedule to the desired date and time when the type of the event is a second type, and the desired date and time of the event included in the schedule information does not overlap with desired date and time of a confirmed schedule or a changeable schedule of the member participating in the event,
slides the desired date and time of the event or the desired date and time of the changeable schedule of the member participating in the event, within a buffer time set in advance by a unit time when the desired date and time of the event included in the schedule information overlaps with the desired date and time of the confirmed schedule or the changeable schedule of the member participating in the event, and sets a changeable schedule to the slid desired date and time when an overlap between the desired date and time of the event included in the schedule information and the desired date and time of the confirmed schedule or the changeable schedule of the member participating in the event is eliminated as a result obtained by sliding the desired date and time of the event or the desired date and time of the changeable schedule, and
sets the changeable schedule as a confirmed schedule of the desired date and time at a predetermined timing.

2. The schedule setting system according to claim 1, wherein
when the type of the event is the first type, and the desired date and time of the event included in the schedule information overlaps with desired date and time of a changeable schedule of the member participating in the event, the control unit slides the overlapping desired date and time of the changeable schedule within the buffer time by a unit time, and when the overlap between the desired date and time of the event and the desired date and time of the confirmed schedule or the changeable schedule of the member participating in the event is eliminated as a result obtained by sliding the desired date and time of the changeable schedule, the control unit sets a changeable schedule to the slid desired date and time.

3. The schedule setting system according to claim 1, wherein
when the type of the event is the second type, and the desired date and time of the event included in the schedule information overlaps with the desired date and time of the confirmed schedule or the changeable schedule of the member participating in the event, the control unit slides the desired date and time of the event within the buffer time by a unit time, and when the overlap between the desired date and time of the event and the desired date and time of the confirmed schedule or the changeable schedule of the member participating in the event is eliminated as a result obtained by sliding the overlapping desired date and time of the event, the control unit sets a changeable schedule to the slid desired date and time.

4. The schedule setting system according to claim 1, wherein
when the type of the event is the second type, and the desired date and time of the event included in the schedule information overlaps with the desired date and time of the confirmed schedule or the changeable schedule of the member participating in the event, the control unit slides the desired date and time of the event within a buffer time set in advance for the event, by a unit time, and
the control unit slides the overlapping desired date and time of the changeable schedule within a buffer time set in advance for the changeable schedule by a unit time when an overlap between the desired date and time of the event and the desired date and time of the changeable schedule of the member participating in the event is not eliminated as a result obtained by sliding the desired date and time of the event within the buffer time set in advance for the event, and sets a changeable schedule to the slid desired date and time when the overlap between the desired date and time of the event and the desired date and time of the confirmed schedule or the changeable schedule of the member participating in the event is eliminated as a result obtained by sliding the desired date and time of the changeable schedule.

5. The schedule setting system according to claim 1, further comprising:
an output unit that outputs information on the slid desired date and time when the overlap between the desired date and time of the event included in the schedule information and the desired date and time of the confirmed schedule or the changeable schedule of the member participating in the event is eliminated as the result obtained by sliding the desired date and time of the event or the desired date and time of the changeable schedule.

6. The schedule setting system according to claim 5, wherein
the output unit issues a notification of a candidate for the slid desired date and time as a schedule candidate, and
the control unit sets desired date and time of a schedule candidate selected from schedule candidates of which the notification has been issued, as the desired date and time of the changeable schedule.

7. The schedule setting system according to claim 1, wherein
when a plurality of combinations of the desired date and time of the event included in the acquired schedule information and desired date and time of a confirmed schedule or a changeable schedule of each member participating in the event are provided as a result obtained by sliding the desired date and time of the changeable schedule, the control unit sets a set changeable schedule to desired date and time corresponding to a pattern of an optimum condition.

8. The schedule setting system according to claim 7, wherein
a set changeable schedule is set to desired date and time having a smallest overlap, as the pattern of the optimum condition, among combinations of the desired date and time of the event included in the acquired schedule information and the desired date and time of the confirmed schedule or the changeable schedule of each member participating in the event.

9. The schedule setting system according to claim 7, wherein
a changeable schedule of an event is set to desired date and time at which a continuous vacant time of each member becomes maximum, as the pattern of the optimum condition, among combinations of the desired date and time of the event included in the acquired schedule information and the desired date and time of the confirmed schedule or the changeable schedule of each member participating in the event.

10. The schedule setting system according to claim 7, wherein
a set changeable schedule is set to earliest desired date and time, as the pattern of the optimum condition, among combinations of the desired date and time of the event included in the acquired schedule information and the desired date and time of the confirmed schedule or the changeable schedule of each member participating in the event.

11. The schedule setting system according to claim 1, wherein
the acquisition unit acquires the schedule information in a list format inputtable by the member, and
when the desired date and time of the event included in the schedule information overlaps with the desired date and time of the confirmed schedule or the changeable schedule of the member participating in the event, the control unit sets a changeable schedule to desired date and time having a high priority among dates and times that do not overlap with the desired date and time of the confirmed schedule or the changeable schedule of the member.

12. The schedule setting system according to claim 11, wherein
the control unit uses, as the desired date and time having the high priority, earliest desired date and time among dates and times that do not overlap with the desired date and time of the confirmed schedule or the changeable schedule of the member participating in the event.

13. A schedule setting server comprising:
an acquisition unit that acquires schedule information including information on a member participating in an event, information on desired date and time of the event, and information on a type of the event; and
a control unit that sets a schedule including a confirmed schedule or a changeable schedule based on the schedule information, wherein
the control unit
sets a confirmed schedule to the desired date and time included in the schedule information when the type of the event is a first type, and the desired date and time of the event included in the schedule information does not overlap with desired date and time of a confirmed schedule of the member participating in the event,
sets a changeable schedule to the desired date and time when the type of the event is a second type, and the desired date and time of the event included in the schedule information does not overlap with desired date and time of a confirmed schedule or a changeable schedule of the member participating in the event,
slides the desired date and time of the event or the desired date and time of the changeable schedule of the member participating in the event, within a buffer time set in advance by a unit time when the desired date and time of the event included in the schedule information overlaps with the desired date and time of the confirmed schedule or the changeable schedule of the member participating in the event, and sets a changeable schedule to the slid desired date and time when an overlap between the desired date and time of the event included in the schedule information and the desired date and time of the confirmed schedule or the changeable schedule of the member participating in the event is eliminated as a result obtained by sliding the desired date and time of the event or the desired date and time of the changeable schedule, and
sets the changeable schedule as a confirmed schedule of the desired date and time at a predetermined timing.

14. A program for causing a computer to execute:
a procedure of acquiring schedule information including information on a member participating in an event, information on desired date and time of the event, and information on a type of the event;
a procedure of setting a schedule including a confirmed schedule or a changeable schedule based on the schedule information; and
a procedure of
setting a confirmed schedule to the desired date and time included in the schedule information when the type of the event is a first type, and the desired date and time of the event included in the schedule information does not overlap with desired date and time of a confirmed schedule of the member participating in the event,
setting a changeable schedule to the desired date and time when the type of the event is a second type, and the desired date and time of the event included in the schedule information does not overlap with desired date and time of a confirmed schedule or a changeable schedule of the member participating in the event,
sliding the desired date and time of the event or the desired date and time of the changeable schedule of the member participating in the event, within a buffer time set in advance by a unit time when the desired date and time of the event included in the schedule information overlaps with the desired date and time of the confirmed schedule or the changeable schedule of the member participating in the event, and setting a changeable schedule to the slid desired date and time when an overlap between the desired date and time of the event included in the schedule information and the desired date and time of the confirmed schedule or the changeable schedule of the member participating in the event is eliminated as a result obtained by sliding the desired date and time of the event or the desired date and time of the changeable schedule, and
setting the changeable schedule as a confirmed schedule of the desired date and time at a predetermined timing.
